(19) United States
(12) Patent Application Publication
(10) Pub. No.: US 2010/0058390 A1
(43) Pub. Date: Mar. 4, 2010

(54) CONTENT ITEM RECOMMENDATION

(75) Inventors: John M. Harris, Glenview, IL (US); Jerome Picault, Paris (FR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/199,564

(22) Filed: Aug. 27, 2008

(51) Int. Cl. H04N 5/445

(52) U.S. Cl. 725/44

(57) ABSTRACT

A content item recommendation system comprises a recommender (203) which generates a set of recommendations for content items available through a first content item distribution system. A coordination processor (205) determines an availability characteristic for a set of content items available through a second content item distribution system of a set of content item distribution systems. The availability characteristic may indicate which content items are available to a user via the second content item distribution system. The modification processor (207) then modifies a recommendation characteristic for the set of recommendations in response to the availability characteristic for the set of content items. The approach may enable or facilitate coordination between different content item distribution systems while still allowing separate and independent operation of the content item distribution systems.

### FIELD OF THE INVENTION

The invention relates to a content item recommendation and in particular, but not exclusively, to recommendation of content items such as television programs.

### BACKGROUND OF THE INVENTION

In recent years, the availability and provision of multimedia and entertainment content has increased substantially. For example, the number of available television and radio channels has grown considerably and the popularity of the Internet has provided new content distribution means. Consequently, users are increasingly provided with a plethora of different types of content from different sources. In order to identify and select the desired content, the user must typically process large amounts of information which can be very cumbersome and impractical.

Accordingly, significant resources have been invested in research into techniques and algorithms that may provide an improved user experience and assist a user in identifying and selecting content, personalizing services etc.

As an example, television recommender systems are becoming popular as a way of helping people navigate a large an increasing number of program options in order to find the programs that fit their individual (or group) preferences. For example, Digital Video Recorders (DVRs) or Personal Video Recorders (PVRs) which comprise functionality for providing recommendations of television programs to the user based on user preferences are becoming increasingly popular. More specifically, such devices can comprise functionality for monitoring the viewing/recording preferences of a user. These preferences can be stored in a user profile which subsequently can be used to autonomously select and recommend suitable television programs for viewing or recording. E.g. a DVR may automatically record programs which are then recommended to the user, for example by inclusion of the automatically recorded programs in a listing of all the programs recorded by the DVR.

In order to enhance the user experience, it is advantageous to personalise the recommendations to the individual user as much as possible. In this context, a recommendation typically consists of predicting how much a user may like a particular content item and recommending it if it is considered of sufficient interest. The process of generating recommendations requires that user preferences have been captured so that they can be used as input data by the prediction algorithm.

In addition to the increasing number of ways content may be distributed to the user, the user also tends to have an increasing number of different options for consuming content. Specifically, consumers increasingly have a number of different devices that can be used to consume various content. For example, many users will have a static set-top box for receiving subscription based television, a mobile phone which may also be used to present video content downloaded via the mobile communication network, a number of computers that may be used to present video content received via the Internet etc.

It is increasingly difficult for a user to navigate between the many available content provision systems and content consuming devices. In particular, as the same content may often be available through different systems and on different devices, the content selection process for the user becomes increasingly difficult. For example, as content recommenders tend to be focussed on a specific system, the benefit to the user is limited as the provided recommendations only relate to the specific system.

Furthermore, providing common recommenders that provide combined content recommendations for all content provision systems available to the user tend to be very complex and impractical. In particular, the distribution systems are typically completely independent of each other whereas the individual recommenders tend to be proprietary and depend on detailed knowledge of the specific system (such as specific program information). Furthermore, as the specific content provision systems that are available to a user vary from user to user, it is not generally possible to generate efficient recommenders that will be suitable for all users.

Hence, an improved content recommendation system would be advantageous and in particular a system allowing increased flexibility, improved coordination between different content distribution systems, improved user experience, facilitated implementation, reduced complexity and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a content item recommendation system comprising: a recommender for generating a set of recommendations for content items available through a first content item distribution system; a coordination processor for determining an availability characteristic for a set of content items available through a second content item distribution system of a set of content item distribution systems; wherein the coordination processor is arranged to modify a recommendation characteristic for the set of recommendations in response to the availability characteristic for the set of content items.

The system may allow improved coordination between different content item distribution systems. Furthermore, the invention may allow reduced complexity and/or facilitated coordination and may in particular allow efficient coordination systems while allowing the content item recommendation to be performed by a recommender dedicated to the individual content item distribution system.

For example, the invention may allow a low complexity system to ensure that recommendations are not provided for a content item via a first content item distribution system if the same content item is available from a content item distribution system that is preferred to the first content item distribution system. For example, if the content item may be provided with less resource usage or at lower cost via the second content item distribution system than via the first content item distribution system.

The availability characteristic specifically reflects the availability of individual content items via the second content item distribution system. The availability characteristic may for example provide one or more availability parameters for each content item of the set of content items, such as e.g. a time of availability (e.g. an on-demand window or a broadcast time), an availability cost (e.g. a monetary cost associated with retrieving the content item) etc.

A content item may for example be an audiovisual clip, a music file, a television program, a text document, an electronic book etc.

According to another aspect of the invention, there is provided a method of operation for a content item recommendation system, the method comprising: generating a set of recommendations for content items available through a first content item distribution system; determining an availability characteristic for a set of content items available through a second content item distribution system of a set of content item distribution systems; and

modifying a recommendation characteristic for the set of recommendations in response to the availability characteristic for the set of content items.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a recommendation system in accordance with some embodiments of the invention;

FIG. 2 illustrates an example of some elements of a content item apparatus in accordance with some embodiments of the invention; and

FIG. 3 illustrates an example of a method of operation for a content item recommendation system in accordance with some embodiments of the invention.

### DETAILED DESCRIPTION OF SOME EMBODIMENTS OF THE INVENTION

The following description focuses on embodiments of the invention applicable to recommendation of audiovisual content items and in particular to recommendation of audiovisual programs such as television programs, films etc. However, it will be appreciated that the invention is not limited to this application but may be applied to many other content items including for example music clips, radio programs, text documents, electronic books etc.

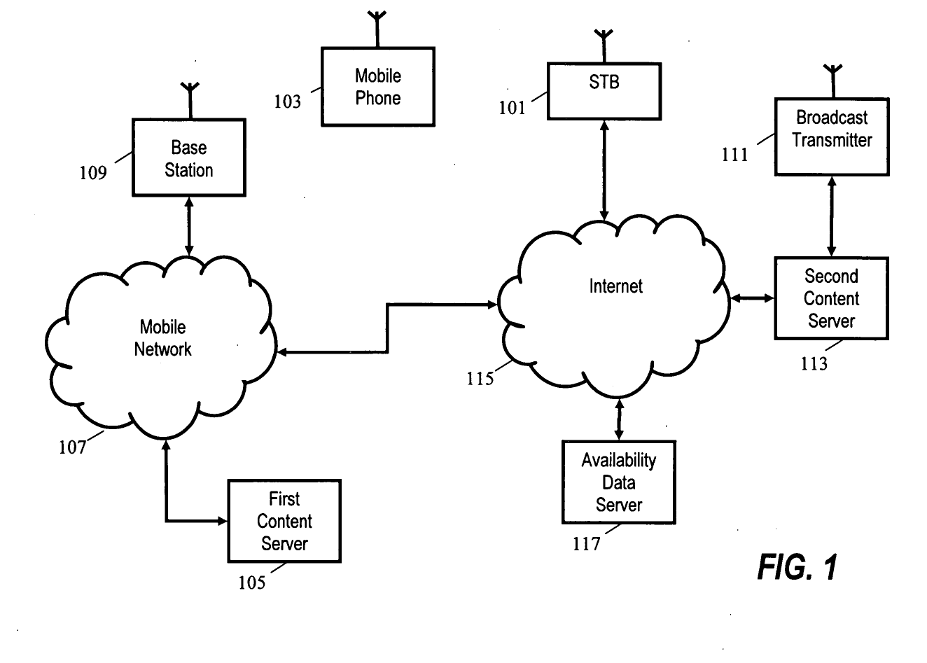

FIG. 1 illustrates an example of a recommendation system in accordance with some embodiments of the invention. In the system, a user utilises two different devices for consumption of audiovisual programs, including television programs, films, documentaries, talk shows etc. Firstly, the user utilises a set-top box 101 which is a stationary device located in the user's home and which is permanently coupled to the user's home television. In addition, the user is able to access audiovisual content items via a mobile application supported by the user's mobile telephone 103. Thus, in the example, the user's mobile phone 103 supports an application allowing specific audiovisual content items to be downloaded to the mobile phone 103 for consumption thereon. As a specific example, the user may download a film to the mobile phone 103 and the mobile phone 103 may then present the film to the user, e.g. on a built-in display of the mobile phone 103.

In the example of FIG. 1, the content item distribution to the mobile phone 103 is supported by a mobile content provision service that uses a first content item distribution system. In the example, the first content item distribution system is equivalent to the elements of the mobile communication system that supports the service. Thus, in the example of FIG. 1, a first content server 105 is arranged to function as a server for the mobile content provision service. The first content server 105 specifically stores a number of content items, such as films and other programs, which are available for distribution to the mobile phones 103. The first content server 105 is capable of receiving requests for specific content items from the mobile phones 103 and to distribute the appropriate content item to the mobile phones 103 in response to the request.

Specifically, the first content server 105 is coupled to a network 107 of the mobile communication system. When a request is received from the first mobile phone 103 via the network 107, the first content server 105 retrieves the selected content item and transmits this to the mobile phone 103 via the network 107 and the base station 109 that currently supports the mobile phone 103.

It will be appreciated that the first content server 105 may furthermore comprise the required functionality for performing a number of supporting processes for the mobile content provision service, including the generation of billing records for the individual user, distributing information of what content is available etc.

The content item distribution for the set-top box 101 is provided via a second content item distribution system which is completely independent of the first content item distribution system. Specifically, the content item distribution for the set-top box 101 does not in any way use the mobile communication system and is completely independent of the operation of the first content server 105. In particular, the operators supporting the content item provision services for the set-top box 101 are independent of the operators of the mobile content provision service.

In the example, the set-top box 101 comprises a television receiver which specifically may be a terrestrial digital television receiver capable of receiving terrestrially broadcast television programs. Thus, in the example the second content item distribution system includes a broadcast transmitter 111 which is coupled to a second content server 113. The second content server 113 specifically generates a number of streams of content items corresponding to a television channel and feeds these to the broadcast transmitter 111 for broadcasting. Thus, the broadcast transmitter 111 may transmit a plurality of television channels which can be received by the set-top box 101.

In some embodiments, some or all of the transmitted television channels may be subscription channels that can only be received by users having subscribed to that channel. For example, the television channels may be encrypted such that they can only be decrypted in a set-top box 101 having a suitable television viewing card. Thus, the specific content available to the individual user by the second content item distribution system may be different for different users depending on the specific subscriptions of the individual user.

In the example, the second content server 113 is furthermore coupled to the Internet 115 to which the set-top box 101 is also coupled. In the example, the set-top box 101 may in addition to the standard broadcast television receiver functionality also comprise on-demand functionality allowing a user to explicitly request a specific content item. In response, the set-top box 101 may contact the second content server 113 which proceeds to download the requested content item directly to the set-top box 101 via the Internet.

As a specific example, in addition to the ability to receive the broadcast television channels, the set-top box 101 may also list a number of e.g. films or other television programs that are available to the user on-demand. If any such on-demand content item is selected, it can be downloaded directly to the set-top box 101 for presentation to the user. In the example, the set-top box 101 furthermore comprises a content item store in which content items may be temporarily stored. Specifically, the set-top box 101 may be a digital video recorder comprising a hard disk on which television programs can be digitally stored. In the example, the content item store may be arranged to store both broadcast as well as on-demand content items.

Thus, in the example of FIG. 1, a user of the set-top box 101 may consume content items that are either directly received from a broadcast by the broadcast transmitter 111, retrieved over the Internet 115 as part of an on-demand service, or retrieved from the local content item store of the set-top box 101. It will be appreciated that the second content server 113 may comprise additional supporting functionality such as functionality for distributing information to the set-top boxes 101 indicating the content items that are available on-demand, for generating billing information for the individual user etc.

In the example of FIG. 1, the first content item distribution system is thus a content item request based content item distribution system wherein content items are only provided in response to a specific request for the content item from the user. In contrast, the second content item distribution system comprises a non-content item request based content item distribution functionality where content items are provided to a user's device without the content items being explicitly requested by the user. Specifically, content items are broadcast to a large number of users by the broadcast transmitter 111 and thus the set-top box 101 receives the content items of the television programs regardless of whether these are of particular interest to the user or not. In the specific example, the second content item distribution system furthermore comprises a request based content item distribution functionality in the form of the ability of the user to specifically request on-demand content items from the second content server 113.

In the example of FIG. 1, the user is thus able to obtain content items through different distribution systems and using different content consumption devices. Furthermore, a large number of content items may be available to the user and accordingly both the mobile phone 103 and the set-top box 101 comprises recommendation functionality for generating specific recommendations of content items that are considered to be of particular interest to the specific user.

Furthermore, the recommendation operations of the set-top box 101 and of the mobile phone 103 are independent of each other. Specifically, the recommender of the set-top box 101 has specifically been designed and optimised for use with the second content item distribution system. Similarly, the recommender of the mobile phone 103 has been designed and optimised specifically for the mobile content provision service provided by the first content server 105.

Thus, in the example the mobile phone 103 may recommend specific content items from the mobile content provision service that are considered to be of particular interest to the user. Similarly, the set-top box 101 may recommend content items from the second content server 113 that are considered to be of particular interest to the user. The recommendations for the set-top box 101 may for example include recommendations of content items that are being broadcast by the broadcast transmitter 111, are available for on-demand download or which are currently stored in the content item store of the set-top box.

However, in a typical scenario a large number of the content items which are available through the mobile content provision service will also be available from the second content server 113. For example, a film which is available for download by the mobile content provision service may also be transmitted by the broadcast transmitter 111 thereby being available for the user to view when at home. As the amount of potentially available content is typically vast, the user will typically not be aware of such clashes between the different content item distribution systems. Therefore the user can often find himself in a situation where a content item downloaded to the mobile phone 103 for viewing thereon will soon after become available on the set-top box 101.

In a typical scenario, it is preferred for the user to receive content items via one of the content item distribution systems relative to the other. Specifically, an associated distribution penalty for one content item distribution system is typically higher than for the other content item distribution system. The distribution penalty may for example be a bandwidth resource usage penalty, a storage resource penalty or may for example be a monetary cost of retrieving the content item. For example, in the example of FIG. 1, it is highly likely that the cost of downloading a film content item from the first content server 105 is substantially higher than an associated cost of simply receiving the broadcast of the same film content item from the broadcast transmitter 111.

It will be appreciated, that the penalty and/or cost of receiving or downloading a content item may be different from different content items within one of the content item distribution systems. Specifically the penalty and/or cost may depend on characteristics of the individual content item (such as the size, quality level, popularity etc). For example, for the mobile content provision service, a monetary cost may be associated with each individual content item. It will also be appreciated that the penalty and/or cost may depend on a characteristic of the individual distribution for the individual content item. For example, the monetary cost penalty for a content item which is simply broadcast on a non-subscription television channel may be zero whereas an individual monetary cost may be associated with each on-demand content item from the second content server 113.

As the content distribution systems, associated content item provision services and recommendation functions are independent of each other, it may accordingly happen that a content item is recommended for specific service despite the content item currently or in the near future being available from the less costly or even free content provision service. Specifically, the recommender of the mobile phone 103 may recommend a content item of specific interest to the user although the same content item may currently or shortly be available for free via the broadcast system. Such events will result in the perceived user benefit of the mobile content provision service being considered relatively low and may discourage the user from downloading content items from this service.

Thus, in the system of FIG. 1, the content recommender systems are not aware of each other and this may result in a sub-optimal solution for the user. For example, the user can be recommended to pay on his mobile phone for a content item that is already available for free on his set-top box. One solution to this problem would be to combine the recommendations of the two different content item distribution systems. However, such an approach is in general not practicable or feasible. Specifically, it will result in substantially more complex recommendation functionality that needs to have knowledge of both content item distribution services and simultaneously take both of these into account. Furthermore, as the recommender function is typically designed by different entities (e.g. the manufacturer of respectively the mobile phone 103 and the set-top box 101) without any knowledge of what other applications or services may be used by the user, it is not generally possible to implement such combined functionality.

In the system of FIG. 1, the recommendations generated by the mobile phone 103 are modified in response to an availability characteristic for content items where the availability characteristic is indicative of the availability for the content items via the second content item distribution system. Specifically, the recommender operation of the mobile phone 103 may be unchanged and completely independent of the existence of the second content item distribution system. However, once the recommendations have been generated, the mobile phone 103 may modify these recommendations depending on the potential availability via the second content item distribution system of the content items being recommended. As a specific example, a recommendation for a content item may be deleted from the list of recommendations if that content item is also available from the second content item distribution system within a given time window.

The mobile phone may retrieve simple availability data that is publicly available and it may use this to modify the recommendations. For example, a simple electronic program guide for the television channels being broadcast may be retrieved by the mobile phone 103 and used to modify the generated recommendations. Thus, a very simple system is achieved which nevertheless ensures a high degree of coordination between the different content item distribution systems that are available to the user. Specifically, a relatively low complexity enhancement to the operation of the mobile phone 103 may allow it to substantially reduce the probability that content items are recommended which can be obtained more cheaply or for free via another system available to the user. Furthermore, this enhancement can be achieved without requiring a close cooperation with the other content item distribution service, or indeed without it being known or approved by the operator of the second content item distribution system.

Thus, in the system of FIG. 1, the mobile phone 103 includes functionality for adding an additional filtering layer on top of the recommender service. This filtering provides an adaptation of the recommendations depending on the other content item distribution systems available to the user. Specifically, it may modify the generated recommendations to take into account other subscriptions that the user may have. The filtering may thus be seen to provide a form of context-aware optimization of multi-source content recommendations.

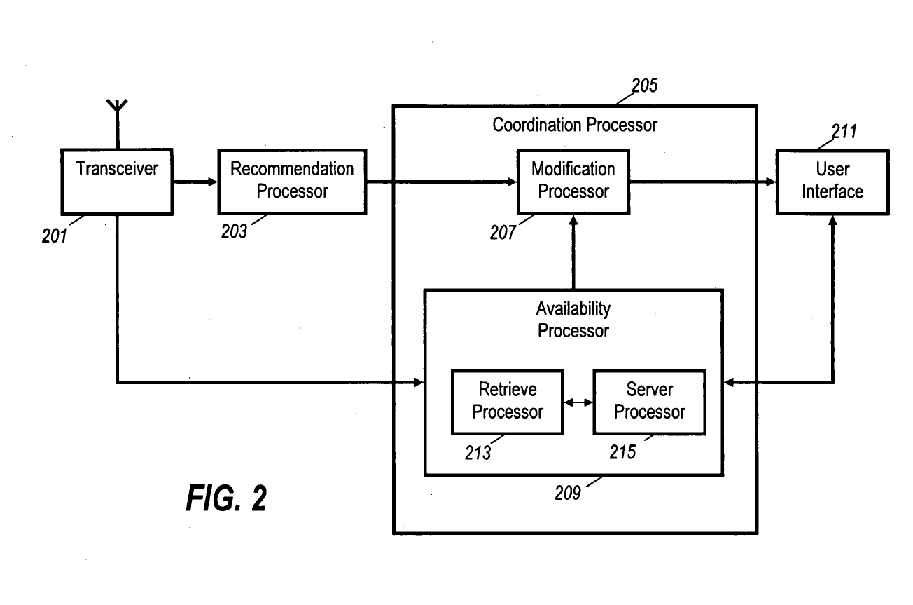

FIG. 2 illustrates an example of some elements of a content item apparatus in accordance with some embodiments of the invention. In particular, FIG. 2 may illustrate elements of the mobile phone 103 and FIG. 2 will be described with specific reference to this example. The mobile phone 103 comprises a transceiver 201 which is arranged to communicate with the mobile communication system and specifically the base station 109 over an air interface of the mobile communication system. Specifically, the transceiver 201 is capable of receiving content items and associated information originating from the first content server 105.

The transceiver 201 is coupled to a recommendation processor 203 which is arranged to generate a set of recommendations for content items that are available from the first content server 105. Specifically, the recommendation processor 203 is provided with characterising data for the content items of the first content server 105. The characterising data is transmitted from the first content server 105 and describes the content that is available from the mobile content provision service. The content item data includes characterising data for the content items including for example metadata describing e.g. a title of the content item, a director for the content item, actors included in the content item, a genre for the content item etc. The recommendation processor 203 evaluates this data with respect to a user preference profile generated in response to previous content item selections by the user. It then generates a set of recommendations for content items.

It will be appreciated that any suitable recommendation algorithm and/or method may be used without subtracting from the invention. It will also be appreciated that a large number of different recommendation algorithms and methods will be known to the person skilled in the art and will for brevity not be further discussed herein.

The generated set of recommendations is fed to a coordination processor 205 which is arranged to modify a recommendation characteristic for the set of recommendations in response to an availability characteristic for content items available via the second content item distribution system. The coordination processor 205 specifically comprises a modification processor 207 which is arranged to modify a recommendation characteristic of one or more of the recommendations of the recommendation set. It furthermore comprises an availability processor 209 which is capable of determining the availability characteristic.

Specifically, the availability processor 209 is arranged to receive availability data from the transceiver 201. The availability data can specifically comprise indications of the content items that are or will be available to the set-top box 101 via the second content item distribution system. As a specific example, the availability processor 209 may receive an electronic program guide for the television channels being broadcast by the broadcast transmitter 111. The electronic program guide can for example include a listing of all the television programs that are to be transmitted in the next week.

The modification processor 207 modifies a recommendation characteristic for a least one of the recommendations in the recommendation set in response to this availability data. In the specific example, the modification processor 207 can specifically for each recommended content item evaluate the availability data to determine whether the recommended content item will be included in a television channel transmitted from the broadcast transmitter 111 in the next week. If so, the priority of the recommendation is changed. E.g. the recommendation may be moved to the bottom of the list or may be deleted completely.

The modified recommendation list is then fed to a user interface 211 of the mobile phone 103 whereby the set of recommendations is presented to the user. Specifically, when a user initialises the mobile content provision service application on the mobile phone 103, the set of recommendations may be provided by the coordination processor 205 and presented on a display of the mobile phone 103. The user may then select one of the recommendations resulting in the mobile phone 103 proceeding to request the selected content item from the first content server 105. The first content server 105 then proceeds to transmit the content item to the mobile phone 103 which may store the content item for later consumption by the user.

The additional filtering provided by the coordination processor 205 may enable a more efficient coordination between the different content provision services that are available to the user. Furthermore, this is achieved with low complexity and very little or no interaction being necessary between the different content item distribution systems. For example, in the specific example, the additional filtering may prevent that a content item that will be available on a television channel in the next week will be recommended to the user.

It will be appreciated that in different embodiments, different availability data may be used to modify the set of recommendations. It will also be appreciated that in different embodiments the availability data may be obtained from different sources and by different means. For example, in some embodiments the availability data may be manually generated by an operator of the mobile content provision service and transmitted directly to the mobile phone 103 from the first content server 105.

In the specific example, the availability processor 209 comprises a retrieve processor 213 which is arranged to retrieve the availability data from a suitable source. Furthermore, the availability processor 209 comprises a server processor 215 which is coupled to the user interface 211 and which is arranged to identify an external server that can provide the availability data for content items of the second content item distribution system.

Specifically, different users may have access to different content distribution systems and to different content provision means within these systems. For example, depending on the specific television channels that the user subscribes to, the specific availability data required may vary. In the specific example of FIG. 2, the server processor 215 is coupled to the user interface 211 and is arranged to request a user input specifying the exact content provision services that the user considers should be taken into account when performing the filtering of the set recommendations. The user can thus indicate the specific television channels that he has access to (and/or the specific subscriptions of the user). In addition, the user can indicate which specific on-demand services are available to him. Based on this content distribution information, the server processor 215 proceeds to not only identify any other content item distribution systems that are available to the user but also to identify one or more servers from which the content item availability data for these systems can be obtained.

In the specific example, the server processor 215 may for example identify the second content server 113 as a suitable source for retrieving availability data for the television programs received by the set-top box 101. The retrieve processor 213 may then proceed to access the second content server 113 via the mobile communication system and the Internet 115.

As another example, the system may comprise an availability data server 117 from which availability data for a number of different content item distribution systems is available. This availability data server 117 may be completely independent of any of the content distribution systems and may be operated by a third-party entity which is independent of the operators of both content item distribution systems. For example, the availability data server 117 may be arranged to implement a web based television guide application. This television guide application may present a customised television guide to an individual user accessing the corresponding webpage. The retrieve processor 213 may on the basis of the information generated by the server processor 215 identify a specific set of television channels that are received by the user set-top box 101 and may be arranged to access the television guide application using this data. Thus, the television guide application returns program listings for the specific television channels that are relevant to the user. The retrieve processor 213 can then proceed to extract the list of content items (television programs) included in these listings. This availability data may then be fed to the modification processor 207 where it is used to modify the set of recommendations.

In the previously provided examples, the availability data is specifically a list of the content items that are available to the user on his set-top box 101 within a given time interval. In the examples, the time interval is a future time interval thus representing content items that will be available to the user on the set-top box 101. However, it will be appreciated that in some scenarios the time interval may alternatively or additionally include a past time interval corresponding to e.g. the availability data comprising indications of content items that have recently been received by the set-top box 101. This may for example be used to reduce the priority for recommendations of content items that are likely to be recorded by the set-top box 101 if they are considered of specific interest to the user (i.e. it is likely that the recommender of the set-top box 101 will have identified the same programs and temporarily stored these in the local data content item store of the set-top box).

It will be appreciated, that the availability data may alternatively or additionally comprise an indication of the content items that are available to the set-top box 101 by the on-demand service provided by the second content server 113. For example, the availability data may in addition to the data from the television listings also comprise a listing of all content items that are available on-demand. Thus, the modification processor 207 may in some embodiments also de-prioritise content item recommendations for content items that are available on request both from the mobile content provision service and via the on-demand service for the set-top box 101.

It will be appreciated that in some embodiments the availability data may not only comprise an indication of whether an individual content item is available but may also provide further characteristics e.g. of this availability. For example, for each content item available on-demand from the second content server 113, the availability data may also include a cost or penalty value of retrieving this. The penalty value may for example be an indication of a bandwidth resource usage or a memory storage resource usage associated with the downloading of the content item. As another example, the cost value may be a monetary cost indicating a price to the user of downloading the content item via the on-demand service. This information may further be taken into consideration when modifying the recommendation characteristics. For example, a monetary cost of downloading the content item via respectively the mobile content provision service and the set-top box service may be used to determine whether the recommendation of the content item should be removed from the set of content items being presented to the user of the mobile phone 103.

It will also be appreciated that in some embodiments the availability data may alternatively or additionally relate to content items stored in the content item store of the set-top box 101. For example, in some embodiments the retrieve processor 213 may alternatively or additionally be able to access the set-top box 101 itself in order to obtain information of which content items are currently stored in the content item store. It will be appreciated that in different embodiments and/or scenarios, different modifications of the generated recommendation set may be applied.

In the specific example, the recommendation priority for a recommendation of the content item is reduced relative to other recommendation priorities of the set if the availability data indicates that the first content item is available via the second content item distribution system. In some embodiments, this reduction may be extreme in the sense that the recommendation of the content item may be removed completely if the content item is available to the user via the set-top box 101. However, it will be appreciated that in other embodiments, a more gradual reduction of priority may be applied. For example, any recommendations of content items also available via the set-top box 101 may be moved to the bottom of the generated recommendation list.

In some embodiments, the recommendation characteristic being modified may specifically be a presentation characteristic for the set of recommendations. For example, any recommendations for content items that are also available to the user via the set-top box 101 may be highlighted e.g. by using a different colour for these recommendations. As another example, recommendations for content items that are also available on the set-top box 101 may be shown separately from content items that are not available on the set-top box 101.

In some embodiments, the coordination processor 205 may request a user input for a recommendation of a content item which is also available by the set-top box 101. It may then modify the recommendation in response to this user input. For example, in response to a detection that a recommendation is for a content item that is also available on the set-top box 101, the coordination processor 205 may query the user to indicate if the recommendation should be deleted from the set or not. If the user so prefers, the recommendation is then deleted.

In some embodiments, the modification processor 207 may be arranged to increase the recommendation priority for a given content item in response to the availability data. For example, if the content item has previously been available either on-demand from the second content server 113 or from the local content item store of the set-top box 101 but the availability data indicates that this is no longer the case, the modification processor 207 may increase the recommendation priority for this content item.

Alternatively or additionally, the content item may be highlighted and/or additional information may be presented to indicate that the content item is no longer available through other means. This may provide an efficient way of notifying the user of the change in the availability of the content item and to encourage the user to obtain the content item from the mobile content provision service while this is still possible.

In some embodiments, the availability data may also comprise an indication that a specific content item has been consumed by a user. For example, the availability data may indicate that the user has consumed a given content item via the set-top box 101. In this case, the recommendation priority of the corresponding content item in the set of recommendations may be reduced or removed completely thereby reflecting the fact that it is unlikely to still be of significant interest to the user.

However, if the availability data indicates that the content item has only been partly consumed and may no longer be available to the user from the content item store of the set-top box 101, the modification processor 207 may substantially increase the recommendation priority in order to notify the user of the possibility of completing the consumption of the content item by downloading this from the first content server 105.

In some embodiments the coordination processor 205 may also be arranged to receive usage data which is indicative of a degree of usage of the second content item distribution system by a user. For example, the availability data may include an identification of all content items that are consumed by the user via the set-top box 101. If a large number of content items are consumed via the set-top box 101 this is indicative of a high degree of usage and thus indicates that the user prefers to consume content items using the set-top box 101. However, if only a low number of content items are consumed by the set-top box 101, this is indicative of a low degree of usage and thus indicates that the user does not have a high preference for consuming content items via the set-top box 101. In particular, the relative preference of the user for consuming content by the set-top box 101 and the mobile phone 103 may be determined in response to a comparison of the number of content items that are consumed using each device.

In some embodiments, the modification of the recommendation characteristic performed by the modification processor 207 may depend on this degree of usage and thus the perceived relative user preference of the set-top box 101 and the mobile phone 103. For example, if the comparison indicates that the user prefers to consume content via the mobile phone 103, the modification processor 207 may proceed to not make any modifications of the recommendations based on the availability of content items via the second content item distribution system. In contrast, if the user strongly prefers to consume content items via the set-top box 101, all recommendations for content items also available via this may be removed from the set of recommendations.

The availability data may specifically indicate a time interval in which the individual content items may be available from the second content item distribution system. For example, for the television program broadcasting, the availability data may indicate a time of transmission, for the content item store the availability data may indicate a remaining storage time before deletion, and for on-demand content items the availability data may indicate a time interval in which the content items are available for downloading. The modification of the recommendation characteristic may take this into account for example by the reduction of the recommendation priority being dependent on how long the content items will be available via the set-top box 101. As another example, the presentation of the recommendation may be associated with information describing when the corresponding content items will be available on the set-top box 101.

Thus, the described system may provide many advantages and allow improved recommendation which takes into account the existence of other content provision services and content item distribution systems available to the user. Furthermore, the system may be implemented with low complexity and in particular allows the recommender functionalities of the different systems to be independent of each other. Indeed, the modification of the recommendations of one system depending on another system may be performed without any consideration of the recommendations or user preferences of the other system.

The approach may allow an improved recommendation and may for example allow the generated recommendations to emphasize content items that are not available to the user through a cheaper or more practical system. For example, it may prevent recommendation of expensive content items that are already available at no cost to the user. Thus, the system may provide an improved user experience and may in particular allow an improved user experience to be provided by the mobile content provision service.

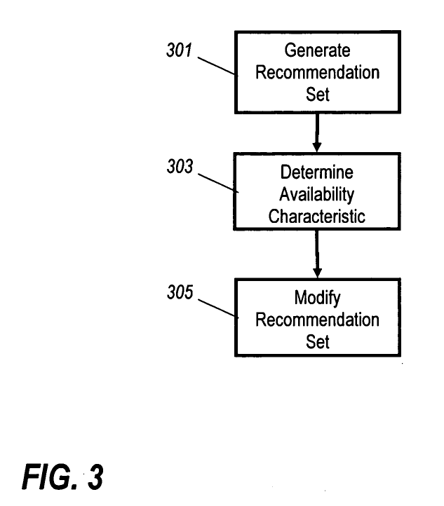

FIG. 3 illustrates an example of a method of operation for a content item recommendation system in accordance with some embodiments of the invention.

The method initiates in step 301 wherein a set of recommendations is generated for content items available through a first content item distribution system. Step 301 is followed by step 303 wherein an availability characteristic is determined for a set of content items available through a second content item distribution system of a set of content item distribution systems. Step 303 is followed by step 305 wherein a recommendation characteristic is modified for the set of recommendations in response to the availability characteristic for the set of content items.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A content item recommendation system comprising:
a recommender for generating a set of recommendations for content items available through a first content item distribution system;
a coordination processor for determining an availability characteristic for a set of content items available through a second content item distribution system of a set of content item distribution systems; wherein
the coordination processor is arranged to modify a recommendation characteristic for the set of recommendations in response to the availability characteristic for the set of content items.

2. The content recommendation system of claim 1 wherein the coordination processor is arranged to modify a recommendation priority of a first recommendation of the set of recommendations for a first content item in response to a component of the availability characteristic relating to the first content item.

3. The content recommendation system of claim 2 wherein the coordination processor is arranged to reduce the recommendation priority relative to other recommendation priorities for the set of recommendations in response to the availability characteristic indicating that the first content item is available via the second content item distribution system.

4. The content recommendation system of claim 2 wherein the coordination processor is arranged to increase the recommendation priority relative to other recommendation priorities for the set of recommendations in response to the availability characteristic indicating that the first content item is no longer available via the second content item distribution system.

5. The content recommendation system of claim 1 further comprising a store for storing content items of the second content item distribution system, the storing of content items in the store being time limited, and wherein the availability characteristic is indicative of an availability of content items in the store.

6. The content recommendation system of claim 5 wherein the coordination processor is arranged to increase the recommendation priority relative to other recommendation priorities for the set of recommendations in response to the availability characteristic indicating that a previously stored content item is no longer available from the store.

7. The content recommendation system of claim 6 wherein the coordination processor is arranged to modify the increase of the recommendation priority in response to a detection that the previously stored content item has been partly consumed.

8. The content recommendation system of claim 1 wherein the recommendation characteristic is a presentation characteristic for the set of recommendations.

9. The content recommendation system of claim 1 wherein the availability characteristic is indicative of a future availability of at least some content items of the set of content items.

10. The content recommendation system of claim 1 wherein an associated distribution penalty for the first content item distribution system is higher than for the second content item distribution system.

11. The content recommendation system of claim 1 further comprising:
a receiver for receiving a distribution indication of content item distribution systems accessible to a user;
and wherein the coordination processor is arranged to identify the second content item distribution system in response to the distribution indication.

12. The content recommendation system of claim 11 further comprising:
a server processor for identifying an external server comprising availability data for content items of the second content item distribution system in response to the distribution indication; and
a retrieve processor for retrieving content item availability data for the second content item distribution system from the external server; and
wherein the coordination processor is arranged to determine the availability characteristic in response to the content item availability data.

13. The content recommendation system of claim 1 wherein the first content item distribution system is a content item request based content item distribution system and the second content item distribution system is arranged to perform non-content item request based content item distribution.

14. The content recommendation system of claim 1 wherein the coordination processor is arranged to request a user input for a first recommendation for a first content item for which the availability characteristic is indicative of an availability of the first content item from the second content item distribution system, and to modify the first recommendation in response to the user input.

15. The content recommendation system of claim 1 wherein the availability characteristic may be indicative of a time interval of availability from the second content item distribution system of at least one content item of the set of content items.

16. The content recommendation system of claim 1 wherein the first content item distribution system supports content item distribution to mobile content item consumption devices; and the second content item distribution system is arranged to support stationary content item consumption devices.

17. The content recommendation system of claim 1 wherein the coordination processor is arranged to modify the recommendation characteristic without considering recommendation data for the set of content items.

18. The content recommendation system of claim 1 wherein the coordination processor may be arranged to modify the recommendation characteristic for a first content item in response to an indication that a corresponding content item received from the second content item distribution system has been consumed.

19. The content recommendation system of claim 1 wherein the coordination processor is further arranged to receive usage data indicative of a degree of usage of the second content item distribution system by a user, and to modify the recommendation characteristic in response to the usage data.

20. A method of operation for a content item recommendation system, the method comprising:
generating a set of recommendations for content items available through a first content item distribution system;
determining an availability characteristic for a set of content items available through a second content item distribution system of a set of content item distribution systems; and
modifying a recommendation characteristic for the set of recommendations in response to the availability characteristic for the set of content items.
